(19) United States
(12) Patent Application Publication
(10) Pub. No.: US 2024/0354415 A1
(43) Pub. Date: Oct. 24, 2024

(54) Method and system for integrity protection for accelerator device firmware using virtualization-based security

(71) Applicants: Vinupama GODAVARTHI, Folsom, CA (US); Venkat GOKULRANGAN, Portland, OR (US); Kunal MEHTA, Hillsboro, OR (US); Satyanantha MUSUNURI, San Ramon, CA (US)

(72) Inventors: Vinupama GODAVARTHI, Folsom, CA (US); Venkat GOKULRANGAN, Portland, OR (US); Kunal MEHTA, Hillsboro, OR (US); Satyanantha MUSUNURI, San Ramon, CA (US)

(21) Appl. No.: 18/757,621

(22) Filed: Jun. 28, 2024

(51) Int. Cl. G06F 21/57; G06F 12/1009

(52) U.S. Cl. CPC G06F 21/572; G06F 12/1009; G06F 2212/1052

(57) ABSTRACT

A method and system for security protection for firmware of an accelerator by leveraging Virtualization-Based Security (VBS). A memory space is allocated for firmware of an accelerator from a Kernel Data Protection (KDP)-protected region of a system memory. The KDP-protected region is a specific area of the system memory that is protected by KDP. The firmware of the accelerator is placed in the KDP-protected region. A device memory management unit (MMU) page table corresponding to the memory space allocation for the firmware of the accelerator may be generated and placed in the KDP-protected region. A device driver of the accelerator sets attributes of page table entries of the device MMU page table appropriately, and accesses to the system memory may be controlled based on the attributes of the page table entries of the device MMU page table.

### BACKGROUND

Modern system on chips (SOCs) include accelerator devices such as a neural network accelerator, a digital signal processor, etc. used in artificial intelligence (AI) or other types of workloads. These accelerators execute complex firmware (FW) stacks, and the integrity of such stacks need to be verified before execution by the accelerator. For ease of deployment, flash size, and product cost considerations, these FW stacks are packaged and distributed with the accelerator device driver software.

The accelerator device driver software executes on a host processor in the operating system environment and loads and verifies the accelerator device firmware in the driver-allocated system memory. The problem is that the accelerator device firmware is in operating system's ring 0 memory and is subject to ring 0 vulnerabilities. System resources and hardware are divided into different privilege levels (“rings”) for security and stability reasons. Typically, the rings are labeled from 0 to 3, with ring 0 being the most privileged (kernel mode) and ring 3 being the least privileged (user mode). Ring 0 memory is where the kernel and core operating system functions reside. The ring 0 vulnerabilities could compromise the integrity of the accelerator device firmware which in turn could compromise the integrity of application workloads (e.g., Al workloads). This increases security risk for the workloads in client systems (e.g., personal computer (PC)).

A device accelerator read-only memory (ROM) or a secure processor in an SOC can verify the integrity of the device firmware in a protected memory region enforced by a memory protection unit (MPU). These options require a device ROM or a secure processor handling for the accelerator along with MPU support in hardware (HW). However, adding a dedicated ROM causes increased product cost while using a security processor to perform such operations in a current Neural Network Processing Unit (NPU) adds complexity and risk to engineering flows.

### BRIEF DESCRIPTION OF THE FIGURES

Some examples of apparatuses and/or methods will be described in the following by way of example only, and with reference to the accompanying figures, in which

FIG. 1 is a block diagram of an example system;

FIG. 2 shows an example system wherein integrity of accelerator device firmware is protected using Virtualization-Based Security (VBS);

FIG. 3 shows a detailed structure of the example system for protection of accelerator firmware by leveraging VBS;

FIG. 4 is a flow diagram of an example process for security protection for firmware of an accelerator by leveraging VBS;

FIG. 5 is a block diagram of an electronic apparatus incorporating at least one electronic assembly and/or method described herein;

FIG. 6 illustrates a computing device in accordance with one implementation of the invention; and

FIG. 7 shows an example of a higher-level device application for the disclosed embodiments.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example,” “in examples,” “in some examples,” and/or “in various examples,” each of which may refer to one or more of the same or different examples. Furthermore, the terms “comprising,” “including,” “having,” and the like, as used with respect to examples of the present disclosure, are synonymous.

Example methods and systems for integrity protection for accelerator firmware leveraging Virtualization-Based Security (VBS) will be disclosed herein. In examples, Windows VBS is leveraged, in conjunction with Virtualization Technologies (VT) capabilities, to protect and harden accelerator firmware (accelerator device firmware). Software (including firmware) hardening refers to the process of enhancing the security of software systems by implementing various measures to reduce vulnerabilities and protect against threats, such as cyberattacks and unauthorized access, etc. The primary goal of software hardening is to make the software more resistant to exploitation by reducing its attack surface and eliminating potential weaknesses.

In examples, the accelerator firmware hardening may be accomplished by extending the VBS Kernel Data Protection (KDP) feature available for kernel mode data to the accelerator firmware and page tables in ring 0 system memory and enforcing protections on device accesses to the system memory using accelerator device memory management unit (MMU) page tables attributes. The page tables are used by the accelerator MMU to translate a virtual address (VA) to a physical address (PA). When done together (or individually as alternative), the accelerator device firmware is hardened both from the host and the device accesses.

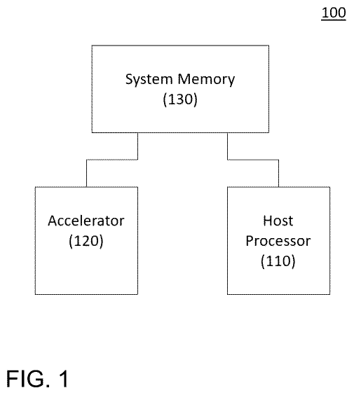

FIG. 1 is a block diagram of an example system. The system 100 is configured for security protection of firmware of an accelerator by leveraging VBS and VT. The system 100 includes a host processor 110, an accelerator 120 (hardware accelerator), and a system memory 130. Accelerator firmware refers to specialized low-level software that operates and manages hardware accelerators. Hardware accelerators are specialized hardware components designed to perform specific tasks more efficiently than general-purpose CPUs. The accelerator 120 may be any accelerator device. For example, the accelerator 120 may be one of a neural network accelerator, a digital signal processor, a graphics processing unit, an encryption processing unit, a data compression processing unit, or the like. The firmware acts as an intermediary between the hardware accelerator and the higher-level software applications or operating systems, ensuring that the hardware performs its intended functions correctly and efficiently.

A device driver of the accelerator 120 that is executed on the host processor 110 is configured to allocate a memory space for firmware of the accelerator 120 from a KDP-protected region of the system memory 130 and place the firmware of the accelerator in the KDP-protected region. The KDP-protected region is a specific area of the system memory that is protected by the KDP features.

The device driver of the accelerator 120 may be configured to generate a device MMU page table (e.g., extended page table (EPT)) corresponding to the memory space allocation for the firmware and place the device MMU page table in the KDP-protected region as well. The device MMU page tables are used by the accelerator MMU to translate a VA to a PA. The device driver of the accelerator 120 may be configured to set attributes of page table entries of the device MMU page table appropriately. For example, the device driver of the accelerator 120 may be configured to set page table entries for accelerator firmware code and/or the device MMU page table itself read-only, execute-only, or read-write but no execute based on microcontroller capabilities in the device MMU page table attributes and set page table entries for data/operation memory as rewritable (RW). Accesses to the system memory may be controlled based on the attributes of the page table entries of the device MMU page table. The host processor 110 may be configured to verify integrity of the firmware of the accelerator 120 (e.g., based on a digital signature) before placing the firmware in the KDP-protected region.

The memory managed by KDP is always verified by a secure kernel and protected using second level address translation (SLAT) tables by the hypervisor. As a result, no software running in the normal kernel can modify the content of the KDP-protected memory region. KDP relies on VBS, which uses hardware virtualization features to create an isolated environment for security-sensitive operations. This isolation helps protect kernel memory from being accessed or modified by unauthorized code running in other parts of the system. By loading the accelerator firmware into the KDP-protected region of the system memory and, optionally in addition to that, enforcing protections on device accesses to the system memory using accelerator device MMU page tables attributes, the firmware can be protected from malicious attacks, such as buffer overflow attack or attacks using kernel-mode write primitives, etc.

The example schemes disclosed herein significantly raise the security protection levels for the accelerator firmware, as the firmware hardening is enforced by the trusted computing base (TCB) to an otherwise unprotected firmware in ring 0 memory. Further, by not requiring device ROM or FW load by other entities, the example schemes disclosed herein provide security without adding new HW thereby improving time-to-market advantage, while keeping product cost the same as before.

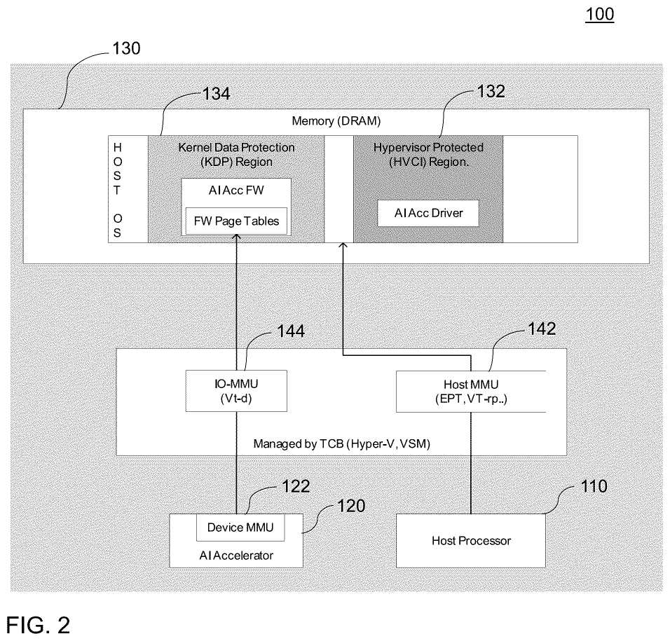

FIG. 2 shows an example system wherein integrity of accelerator device firmware is protected using VBS. The system 100 includes a host processor 110, an accelerator 120, a host MMU 142, an IOMMU 144, and a memory 130 (e.g., a DRAM). The accelerator 120 is a purpose-built processor or component for accelerating a specific function or workload. The accelerator 120 is designed to perform specific computing tasks faster and more efficiently than a general-purpose processor. For example, the accelerator 120 may be an Al accelerator, a graphics processing unit, a digital signal processor, an encryption processing unit, a data compression processing unit, or the like. The accelerator 120 includes a device memory management unit (MMU) 122. The device MMU 122 is a specialized component that manages and controls access to the memory 130 by the accelerator 120.

The host MMU 142 and the IOMMU 144, managed by the trusted computing base (TCB), are used by the host processor 110 and the accelerator 120, respectively, for accessing the memory 130. The host MMU 142 is a component in the system that handles translation of virtual memory addresses to physical memory addresses, among other functions. The host MMU may implement Extended Page Tables (EPT) and Virtualization Technology Redirect Protection (VT-rp). EPT is used to improve the performance of virtual memory management in virtualized environments. EPT is a second-level address translation mechanism that helps in translating the guest-physical addresses (used by virtual machines) to host-physical addresses (used by the hypervisor or host operating system). For example, the EPT may be used (along with other security technologies) to harden the firmware region of an accelerator (e.g., a neural processing unit (NPU)). This may be achieved via KDP, etc. VT-rp is a security feature that provides additional protection for virtualized environments. It focuses on ensuring that the control and redirection of execution in a virtualized environment are handled securely, preventing unauthorized redirection or control of virtualized resources.

The IOMMU 144 is a memory management unit that connects a direct memory access (DMA)-capable I/O bus to the main memory. The IOMMU 144 may translate device-visible virtual addresses to physical addresses, enabling devices to perform DMA to and from locations in the memory 130 that may not be contiguous. The IOMMU 144 may provide isolation between devices by ensuring that a device can only access its own allocated memory regions, preventing malicious or faulty devices from corrupting memory used by other devices or the operating system. Examples of IOMMU implementations include VT-d (Virtualization Technology for Directed I/O).

VT-d is a set of hardware features designed to enhance the performance and security of I/O operations in virtualized environments. VT-d allows for DMA remapping, which ensures that device DMA operations are correctly mapped to the memory spaces of the virtual machines. This prevents unauthorized access to the memory of other VMs, enhancing security. By controlling and remapping DMA operations, VT-d helps protect against DMA attacks, where a device might attempt to access memory regions outside of its allocated space.

VBS is enabled in the system 100. VBS is a windows security model in which a hypervisor and a secure kernel operate in a virtual secure mode at a higher privilege level than ring 0, i.e., ring −1 privilege level. VBS utilizes hardware virtualization to isolate security-sensitive components from the regular operating system, providing enhanced protection against sophisticated attacks. VBS can create an isolated virtual environment that becomes the root of trust of the operating system (OS). This isolated environment can be used to host a number of security solutions, providing them with greatly increased protection from vulnerabilities in the operating system, and preventing the use of malicious exploits which attempt to defeat protections. VBS enforces restrictions to protect vital system and operating system resources, or to protect security assets such as authenticated user credentials. One security solution is memory integrity, which protects and hardens the system by running kernel mode code integrity within the isolated virtual environment of VBS. Kernel mode code integrity is the process that checks all kernel mode drivers and binaries before they are started, and prevents unsigned or untrusted drivers or system files from being loaded into the system memory. Memory integrity also restricts kernel memory allocations that could be used to compromise the system, ensuring that kernel memory pages are only made executable after passing code integrity checks inside the secure runtime environment, and executable pages themselves are never writable. That way, even if there are vulnerabilities like a buffer overflow that allow malware to attempt to modify memory, executable code pages cannot be modified, and modified memory cannot be made executable.

In examples, the accelerator 120 (which does not have built-in protection such as HW root of trust (ROT) or MPU) may benefit from the VBS capabilities to maintain the integrity of its firmware. For example, the Kernel Data Protection (KDP) which is intended for kernel mode code to protect its critical policy and data structures may be leveraged for protection of the accelerator firmware. By leveraging KDP for accelerator firmware, the accelerator firmware is afforded the protections by Ring −1 (VTL1) privilege level on par with the device driver which is protected by Digital Signature Enforcement (DSE), Hypervisor-protected code integrity (HVCI), and Control Flow Integrity (CFI), or the like.

DSE is a VBS capability that ensures only signed drivers to be loaded in ring 0. DSE ensures that only code, files, or documents that have been signed with a valid digital signature can be executed or accessed. This mechanism is used to verify the authenticity and integrity of the signed items, providing a safeguard against malicious or unauthorized modifications.

HVCI is a security feature that ensures only trusted code can execute within the kernel. HVCI leverages VSM to provide hardware-backed protection for kernel-mode code integrity checks, making it more difficult for attackers to bypass or tamper with critical system components. HVCI, which prevents any non-signed memory from being ever executable, granting the W\hat{ }X (a page that is either writable or executable, but never both) condition. HVCI is a VBS capability that ensures that a writable page cannot be marked executable or vice-versa (i.e., W\hat{ }X), which means that there cannot be code generation i.e., dynamic code pages are not allowed in kernel.

CFI is a security feature designed to protect software from control flow hijacking attacks, which occur when an attacker manipulates the control flow of a program to execute arbitrary code. CFI works by ensuring that the execution flow of a program follows the paths defined by its control flow graph (CFG), thereby preventing malicious redirection of the program's execution.

KDP is a security feature introduced to enhance the security of the operating system. Its primary goal is to protect the integrity of critical kernel data structures from unauthorized modifications, which can be exploited by malicious software (malware) to gain control over the system or compromise its security. KDP leverages VBS to provide these protections. In VBS environments, the normal kernel runs in a virtualized environment called VTL0 (virtual trust level 0), while the secure kernel runs in a more secure and isolated environment called VTL1. KDP is intended to protect drivers and software running in the kernel (i.e., the OS code) against data-driven attacks. The memory managed by KDP is always verified by the secure kernel (VTL1) and protected using second level address translation (SLAT) tables by the hypervisor. As a result, no software running in the normal kernel (VTL0) can modify the content of the protected memory. KDP relies on VBS, which uses hardware virtualization features to create an isolated environment for security-sensitive operations. This isolation helps protect kernel memory from being accessed or modified by unauthorized code running in other parts of the system.

In examples, specific areas of the memory 130 (i.e., a system memory) are reserved/allocated as a hypervisor-protected region (HVCI region) 132 and a KDP-protected region 134. The accelerator device driver is loaded into the hypervisor-protected region 132 while the accelerator firmware and the page tables for the accelerator firmware are loaded into the KDP-protected region 134 of the memory 130.

The HVCI region 132 in the system memory is a part of VBS framework. HVCI uses the hypervisor to create isolated memory regions. This isolation prevents unauthorized code from modifying critical kernel structures and data. During system boot, the hypervisor initializes and sets up the VBS environment, including the HVCI region 132. The HVCI region 132 is a protected area of memory dedicated to storing code and data that HVCI will manage. When a code is loaded into the kernel, HVCI verifies integrity of the code by checking its digital signature. If the code is signed by a trusted entity and passes the integrity check, it is allowed to execute. HVCI continuously monitors and enforces code integrity at runtime. Any attempt to execute unsigned or tampered code in the kernel is blocked, preventing potential security breaches. The hypervisor enforces strict memory protections, ensuring that only authorized code can access or modify the HVCI region. This prevents attackers from bypassing HVCI by directly modifying memory.

The KDP-protected region 134 is a specific area of the system memory that is protected by the KDP feature. KDP designates certain regions of kernel memory as protected. These regions typically include critical data structures and code that must remain immutable to maintain system integrity and security. During system boot, VBS initializes and sets up the secure environment, including the KDP-protected regions. The KDP-protected regions are marked and managed by the hypervisor to ensure they remain protected. KDP enforces that the designated memory regions are read-only. Any attempt to write to these write-protected regions is blocked by the hypervisor, ensuring that only legitimate, authorized code can make changes to the protected data. KDP also continuously monitors the integrity of the KDP-protected region 134. If any unauthorized modification attempts are detected, they are blocked, and appropriate security responses can be triggered.

As part of the accelerator device bring-up flow, the accelerator device driver allocates system memory (e.g., ring 0 memory) for firmware code and data. The accelerator device driver verifies the firmware, prepares the accelerator device MMU page tables corresponding to the memory allocation for the accelerator, and places the firmware code and data and the accelerator device MMU page tables in a KDP-protected region of the system memory. As part of the preparation of the accelerator device MMU page tables, the accelerator device driver may set the page table entries (PTE) attributes appropriately (e.g., RO or W\hat{ }X), and access to the memory region may be controlled based on the PTE attributes. A page table is a data structure to keep track of the mapping between the virtual addresses and the corresponding physical addresses in the system memory. A page table entry (PTE) is an entry in the page table that stores information about a particular page of the memory. Each PTE contains information such as the physical address of the page in memory, whether the page is present in memory or not, whether it is writable or not, and access permissions, etc. In examples, the KDP protection and the PTE protection may be implemented independently/separately (i.e., only one of them is implemented) or in combination (i.e., both are implemented simultaneously). The KDP and/or PTE protections help harden the firmware from the malicious and/or vulnerable host as well as device accesses.

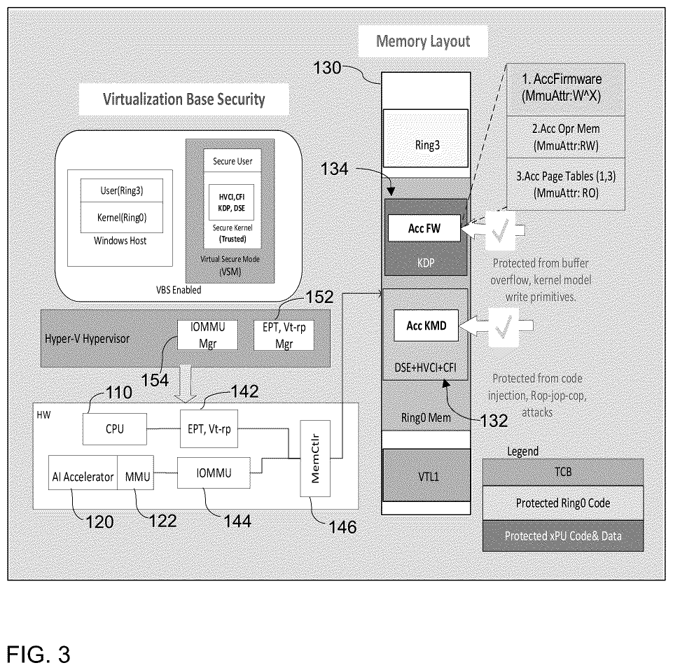

FIG. 3 shows a detailed structure of the example system for protection of accelerator firmware by leveraging VBS in conjunction with VT. FIG. 3 shows additional details of the system 100 shown in FIG. 2 and the same features will not be explained again for simplicity. The system 100 includes a host processor 110, an accelerator device 120, a host MMU 142, an IOMMU 144, and a memory 130 (e.g., a DRAM). The host MMU 142 and the IOMMU 144 are used by the host processor 110 and the accelerator 120, respectively, for accessing the memory 130 via the memory controller 146.

The host MMU manager 152 is responsible for managing and controlling the host's MMU hardware 142. The host MMU manager 152 operates within the OS kernel and performs several essential tasks related to memory management such as address translation, memory protection, paging and segmentation, virtual memory management, cache management, etc. The IOMMU manager 154 is a component responsible for configuring, managing, and controlling the IOMMU hardware 144. The IOMMU manager 154 typically runs as part of the operating system's kernel or as a part of a hypervisor in virtualized environments.

VBS is enabled in the system 100, and the system 100 runs in a virtual secure mode (VSM). A VSM is a security feature designed to enhance the security of virtualized environments by providing a secure execution environment for sensitive operations, such as credential protection and authentication. VSM leverages the hardware virtualization features of CPUs to create a separate, isolated environment called secure kernel. This environment is isolated from the rest of the operating system and runs at a higher privilege level than the regular kernel, typically in Ring −1. The security features such as HVCI, CFI, KDP, DSE as explained above are implemented in the secure kernel.

An example memory layout is shown in FIG. 3. The memory (e.g., ring 0 memory) includes a hypervisor-protected region (HVCI region) 132 and a KDP-protected region 134. In examples, the accelerator device driver is loaded in the hypervisor-protected region 132 and the accelerator device firmware is loaded in the KDP-protected region 134.

The accelerator device driver allocates system memory (ring 0 memory) for the firmware code and data. The accelerator device driver verifies the integrity of the firmware before placing the firmware in the system memory, prepares the device MMU page tables corresponding to the memory allocation for the accelerator firmware, and places them in a KDP-protected memory region 134. The accelerator device driver sets the PTE attributes in the device MMU page tables appropriately (e.g., RO or W\hat{ }X). For example, the device driver of the accelerator 120 may set page table entries for accelerator firmware code and/or the device MMU page table itself read-only, execute-only, or read-write but no execute based on microcontroller capabilities in the device MMU page table attributes and set page table entries for data/operation memory as rewritable (RW). Accesses to the system memory may then be controlled based on the attributes of the page table entries of the device MMU page table.

The memory managed by KDP is always verified by the secure kernel (VTL1) and protected using second level address translation (SLAT) tables by the hypervisor. As a result, no software running in the normal kernel (VTL0) can modify the content of the KDP-protected memory region. KDP relies on VBS, which uses hardware virtualization features to create an isolated environment for security-sensitive operations. This isolation helps protect kernel memory from being accessed or modified by unauthorized code running in other parts of the system. Therefore, by loading the accelerator firmware into the KDP-protected region 134 of the system memory and, optionally in addition to that, setting the PTE attributes of the MMU page tables for the firmware and enforcing protections on device accesses to the system memory based on the accelerator device MMU page tables attributes, the firmware can be protected from malicious attacks, such as buffer overflow attack or attacks using kernel-mode write primitives, etc.

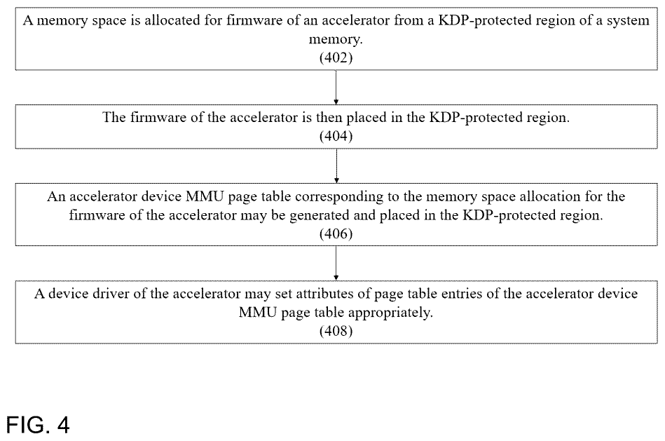

FIG. 4 is a flow diagram of an example process for security protection for firmware of an accelerator by leveraging VBS. A memory space is allocated for firmware of an accelerator from a KDP-protected region of a system memory (402). The KDP-protected region is a specific area of the system memory that is protected by a KDP feature. The firmware of the accelerator is then placed in the KDP-protected region (404).

In some examples, an accelerator device MMU page table corresponding to the memory space allocation for the firmware of the accelerator may be generated and placed in the KDP-protected region as well (406). A device driver of the accelerator may set attributes of page table entries of the accelerator device MMU page table appropriately (408). For example, the device driver may set page table entries for accelerator firmware code and the device MMU page table read-only, execute-only, or read-write but no execute based on microcontroller capabilities in the device MMU page table attributes. Accesses to the system memory may then be controlled based on the attributes of the page table entries of the device MMU page table. The integrity of the firmware of the accelerator may be verified before placing the firmware in the KDP-protected region. The accelerator may be one of a neural network accelerator, a digital signal processor, a graphics processing unit, an encryption processing unit, a data compression processing unit, or the like.

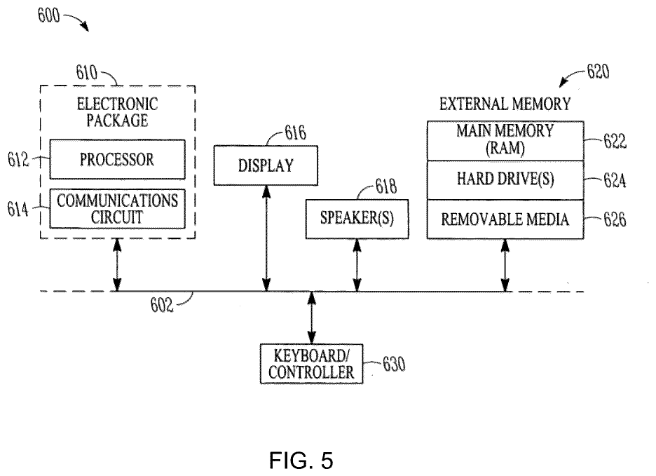

FIG. 5 is a block diagram of an electronic apparatus 600 incorporating at least one electronic assembly and/or method described herein. Electronic apparatus 600 is-merely one example of an electronic apparatus in which forms of the electronic assemblies and/or methods described herein may be used. Examples of an electronic apparatus 600 include, but are not limited to, personal computers, tablet computers, mobile telephones, game devices, MP3 or other digital music players, etc. In this example, electronic apparatus 600 comprises a data processing system that includes a system bus 602 to couple the various components of the electronic apparatus 600. System bus 602 provides communications links among the various components of the electronic apparatus 600 and may be implemented as a single bus, as a combination of busses, or in any other suitable manner.

An electronic assembly 610 as describe herein may be coupled to system bus 602. The electronic assembly 610 may include any circuit or combination of circuits. In one embodiment, the electronic assembly 610 includes a processor 612 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 610 are a custom circuit, an application-specific integrated circuit (ASlC), or the like, such as, for example, one or more circuits (such as a communications circuit 614) for use in wireless devices like mobile telephones, tablet computers, laptop computers, two-way radios, and similar electronic systems. The IC can perform any other type of function.

The electronic apparatus 600 may also include an external memory 620, which in turn may include one or more memory elements suitable to the particular application, such as a main memory 622 in the form of random access memory (RAM), one or more hard drives 624, and/or one or more drives that handle removable media 626 such as compact disks (CD), flash memory cards, digital video disk (DVD), and the like.

The electronic apparatus 600 may also include a display device 616, one or more speakers 618, and a keyboard and/or controller 630, which can include a mouse, trackball, touch screen, voice-recognition device, or any other device that permits a system user to input information into and receive information from the electronic apparatus 600.

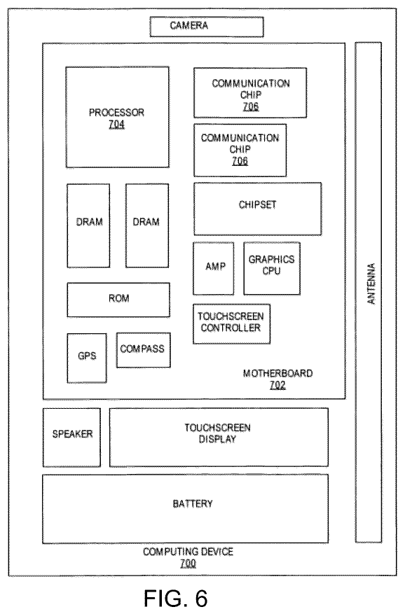

FIG. 6 illustrates a computing device 700 in accordance with one implementation of the invention. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704. Depending on its applications, computing device 700 may include other components that may or may not be physically and electrically coupled to the board 702. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others. The processor 704 of the computing device 700 includes an integrated circuit die packaged within the processor 704. In some implementations of the invention, the integrated circuit die of the processor includes one or more devices that are assembled in an ePLB or eWLB based POP package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory. The communication chip 706 also includes an integrated circuit die packaged within the communication chip 706. In accordance with another implementation of the invention, the integrated circuit die of the communication chip includes one or more devices that are assembled in an ePLB or eWLB based POP package that that includes a mold layer directly contacting a substrate, in accordance with implementations of the invention.

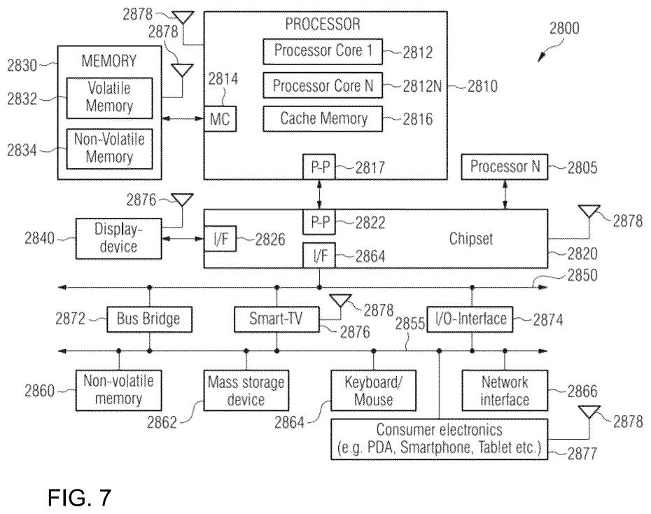

FIG. 7 is included to show an example of a higher level device application for the disclosed embodiments. The MAA cantilevered heat pipe apparatus embodiments may be found in several parts of a computing system. In an embodiment, the MAA cantilevered heat pipe is part of a communications apparatus such as is affixed to a cellular communications tower. The MAA cantilevered heat pipe may also be referred to as an MAA apparatus. In an embodiment, a computing system 2800 includes, but is not limited to, a desktop computer. In an embodiment, a system 2800 includes, but is not limited to a laptop computer. In an embodiment, a system 2800 includes, but is not limited to a netbook. In an embodiment, a system 2800 includes, but is not limited to a tablet. In an embodiment, a system 2800 includes, but is not limited to a notebook computer. In an embodiment, a system 2800 includes, but is not limited to a personal digital assistant (PDA). In an embodiment, a system 2800 includes, but is not limited to a server. In an embodiment, a system 2800 includes, but is not limited to a workstation. In an embodiment, a system 2800 includes, but is not limited to a cellular telephone. In an embodiment, a system 2800 includes, but is not limited to a mobile computing device. In an embodiment, a system 2800 includes, but is not limited to a smart phone. In an embodiment, a system 2800 includes, but is not limited to an internet appliance. Other types of computing devices may be configured with the microelectronic device that includes MAA apparatus embodiments.

In an embodiment, the processor 2810 has one or more processing cores 2812 and 2812N, where 2812N represents the Nth processor core inside processor 2810 where N is a positive integer. In an embodiment, the electronic device system 2800 using a MAA apparatus embodiment that includes multiple processors including 2810 and 2805, where the processor 2805 has logic similar or identical to the logic of the processor 2810. In an embodiment, the processing core 2812 includes, but is not limited to, pre-fetch logic to fetch instructions, decode logic to decode the instructions, execution logic to execute instructions and the like. In an embodiment, the processor 2810 has a cache memory 2816 to cache at least one of instructions and data for the MAA apparatus in the system 2800. The cache memory 2816 may be organized into a hierarchal structure including one or more levels of cache memory.

In an embodiment, the processor 2810 includes a memory controller 2814, which is operable to perform functions that enable the processor 2810 to access and communicate with memory 2830 that includes at least one of a volatile memory 2832 and a non-volatile memory 2834. In an embodiment, the processor 2810 is coupled with memory 2830 and chipset 2820. The processor 2810 may also be coupled to a wireless antenna 2878 to communicate with any device configured to at least one of transmit and receive wireless signals. In an embodiment, the wireless antenna interface 2878 operates in accordance with, but is not limited to, the IEEE 802.11 standard and its related family, Home Plug AV (HPAV), Ultra Wide Band (UWB), Bluetooth, WiMax, or any form of wireless communication protocol.

In an embodiment, the volatile memory 2832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2834 includes, but is not limited to, flash memory, phase change memory (PCM), read-only memory (ROM), electrically erasable programmable read-only memory (EEPROM), or any other type of non-volatile memory device.

The memory 2830 stores information and instructions to be executed by the processor 2810. In an embodiment, the memory 2830 may also store temporary variables or other intermediate information while the processor 2810 is executing instructions. In the illustrated embodiment, the chipset 2820 connects with processor 2810 via Point-to-Point (PtP or P-P) interfaces 2817 and 2822. Either of these PtP embodiments may be achieved using a MAA apparatus embodiment as set forth in this disclosure. The chipset 2820 enables the processor 2810 to connect to other elements in the MAA apparatus embodiments in a system 2800. In an embodiment, interfaces 2817 and 2822 operate in accordance with a PtP communication protocol such as the Intel® QuickPath Interconnect (QPI) or the like. In other embodiments, a different interconnect may be used.

In an embodiment, the chipset 2820 is operable to communicate with the processor 2810, 2805N, the display device 2840, and other devices 2872, 2876, 2874, 2860, 2862, 2864, 2866, 2877, etc. The chipset 2820 may also be coupled to a wireless antenna 2878 to communicate with any device configured to at least do one of transmit and receive wireless signals.

The chipset 2820 connects to the display device 2840 via the interface 2826. The display 2840 may be, for example, a liquid crystal display (LCD), a plasma display, cathode ray tube (CRT) display, or any other form of visual display device. In and embodiment, the processor 2810 and the chipset 2820 are merged into a MAA apparatus in a system. Additionally, the chipset 2820 connects to one or more buses 2850 and 2855 that interconnect various elements 2874, 2860, 2862, 2864, and 2866. Buses 2850 and 2855 may be interconnected together via a bus bridge 2872 such as at least one MAA apparatus embodiment. In an embodiment, the chipset 2820 couples with a non-volatile memory 2860, a mass storage device(s) 2862, a keyboard/mouse 2864, and a network interface 2866 by way of at least one of the interface 2824 and 2874, the smart TV 2876, and the consumer electronics 2877, etc.

In an embodiment, the mass storage device 2862 includes, but is not limited to, a solid state drive, a hard disk drive, a universal serial bus flash memory drive, or any other form of computer data storage medium. In one embodiment, the network interface 2866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 7 are depicted as separate blocks within the MAA apparatus embodiment in a computing system 2800, the functions performed by some of these blocks may be integrated within a single semiconductor circuit or may be implemented using two or more separate integrated circuits. For example, although cache memory 2816 is depicted as a separate block within processor 2810, cache memory 2816 (or selected aspects of 2816) can be incorporated into the processor core 2812.

Where useful, the computing system 2800 may have a broadcasting structure interface such as for affixing the MAA apparatus to a cellular tower.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some examples, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:

An example (e.g., example 1) relates to a method for security protection for firmware of an accelerator. The method includes allocating a memory space for firmware of an accelerator from a KDP-protected region of a system memory, wherein the KDP-protected region is a specific area of the system memory that is protected by KDP, and placing the firmware of the accelerator in the KDP-protected region.

Another example, (e.g., example 2) relates to a previously described example (e.g., example 1), further comprising generating a device MMU page table corresponding to the memory space allocation for the firmware of the accelerator, and placing the device MMU page table in the KDP-protected region.

Another example, (e.g., example 3) relates to a previously described example (e.g., example 2), wherein a device driver of the accelerator sets attributes of page table entries of the device MMU page table, and accesses to the system memory is controlled based on the attributes of the page table entries of the device MMU page table.

Another example, (e.g., example 4) relates to a previously described example (e.g., example 3), wherein the device driver sets page table entries for accelerator firmware code and the device MMU page table read-only, execute-only, or read-write but no execute based on microcontroller capabilities in the device MMU page table attributes.

Another example, (e.g., example 5) relates to a previously described example (e.g., any one of examples 1-4), further comprising verifying integrity of the firmware of the accelerator before placing the firmware in the KDP-protected region.

Another example, (e.g., example 6) relates to a previously described example (e.g., any one of examples 1-5), wherein the accelerator is one of a neural network accelerator, a digital signal processor, a graphics processing unit, an encryption processing unit, or a data compression processing unit.

An example (e.g., example 7) relates to a system configured for security protection of firmware of an accelerator. The system includes a host processor, an accelerator, and a system memory. A device driver of the accelerator is configured to allocate a memory space for firmware of the accelerator from a KDP-protected region of the system memory and place the firmware of the accelerator in the KDP-protected region, wherein the KDP-protected region is a specific area of the system memory that is protected by KDP.

Another example, (e.g., example 8) relates to a previously described example (e.g., example 7), wherein the device driver of the accelerator is configured to generate a device MMU page table corresponding to the memory space allocation for the firmware and place the device MMU page table in the KDP-protected region.

Another example, (e.g., example 9) relates to a previously described example (e.g., example 8), wherein the device driver of the accelerator is configured to set attributes of page table entries of the device MMU page table and accesses to the system memory is controlled based on the attributes of the page table entries of the device MMU page table.

Another example, (e.g., example 10) relates to a previously described example (e.g., example 9), wherein the device driver of the accelerator is configured to set page table entries for accelerator firmware code and/or the device MMU page table read-only, execute-only, or read-write but no execute based on microcontroller capabilities in the device MMU page table attributes.

Another example, (e.g., example 11) relates to a previously described example (e.g., any one of examples 7-10), wherein the processor is configured to verify integrity of the firmware of the accelerator before placing the firmware in the KDP-protected region.

Another example, (e.g., example 12) relates to a previously described example (e.g., any one of examples 7-11), wherein the accelerator is one of a neural network accelerator, a digital signal processor, a graphics processing unit, an encryption processing unit, or a data compression processing unit.

An example (e.g., example 13) relates to a machine-readable medium including code, when executed, to cause a machine to allocate a memory space for firmware of an accelerator from a KDP-protected region of a system memory, wherein the KDP-protected region is a specific area of the system memory that is protected by KDP, and place the firmware of the accelerator in the KDP-protected region.

Another example, (e.g., example 14) relates to a previously described example (e.g., example 13), wherein the code is further to generate a device MMU page table corresponding to the memory space allocation for the firmware of the accelerator, and place the device MMU page table in the KDP-protected region.

Another example, (e.g., example 15) relates to a previously described example (e.g., example 14), wherein the code is further to set attributes of page table entries of the device MMU page table and accesses to the system memory is controlled based on the attributes of the page table entries of the device MMU page table.

Another example, (e.g., example 16) relates to a previously described example (e.g., example 15), wherein the code is further to set page table entries for accelerator firmware code and/or the device MMU page table read-only, execute-only, or read-write but no execute based on microcontroller capabilities in the device MMU page table attributes.

Another example, (e.g., example 17) relates to a previously described example (e.g., any one of examples 13-16), wherein the code is further to verify integrity of the firmware of the accelerator before placing the firmware in the KDP-protected region.

Another example, (e.g., example 18) relates to a previously described example (e.g., any one of examples 13-17), wherein the accelerator is one of a neural network accelerator, a digital signal processor, a graphics processing unit, an encryption processing unit, or a data compression processing unit.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A method for security protection for firmware of an accelerator, comprising:
allocating a memory space for firmware of an accelerator from a Kernel Data Protection (KDP)-protected region of a system memory, wherein the KDP-protected region is a specific area of the system memory that is protected by KDP; and
placing the firmware of the accelerator in the KDP-protected region.

2. The method of claim 1 further comprising:
generating a device memory management unit (MMU) page table corresponding to the memory space allocation for the firmware of the accelerator; and
placing the device MMU page table in the KDP-protected region.

3. The method of claim 2, wherein a device driver of the accelerator sets attributes of page table entries of the device MMU page table, and accesses to the system memory is controlled based on the attributes of the page table entries of the device MMU page table.

4. The method of claim 3, wherein the device driver sets page table entries for accelerator firmware code and the device MMU page table read-only, execute-only, or read-write but no execute based on microcontroller capabilities in the device MMU page table attributes.

5. The method of claim 1 further comprising:
verifying integrity of the firmware of the accelerator before placing the firmware in the KDP-protected region.

6. The method of claim 1, wherein the accelerator is one of a neural network accelerator, a digital signal processor, a graphics processing unit, an encryption processing unit, or a data compression processing unit.

7. A system configured for security protection of firmware of an accelerator, comprising:
a host processor;
an accelerator; and
a system memory,
wherein a device driver of the accelerator is configured to allocate a memory space for firmware of the accelerator from a Kernel Data Protection (KDP)-protected region of the system memory and place the firmware of the accelerator in the KDP-protected region, wherein the KDP-protected region is a specific area of the system memory that is protected by KDP.

8. The system of claim 7 wherein the device driver of the accelerator is configured to generate a device memory management unit (MMU) page table corresponding to the memory space allocation for the firmware and place the device MMU page table in the KDP-protected region.

9. The system of claim 8, wherein the device driver of the accelerator is configured to set attributes of page table entries of the device MMU page table and accesses to the system memory is controlled based on the attributes of the page table entries of the device MMU page table.

10. The system of claim 9, wherein the device driver of the accelerator is configured to set page table entries for accelerator firmware code and/or the device MMU page table read-only, execute-only, or read-write but no execute based on microcontroller capabilities in the device MMU page table attributes.

11. The system of claim 7 wherein the processor is configured to verify integrity of the firmware of the accelerator before placing the firmware in the KDP-protected region.

12. The system of claim 7, wherein the accelerator is one of a neural network accelerator, a digital signal processor, a graphics processing unit, an encryption processing unit, or a data compression processing unit.

13. A machine-readable medium including code, when executed, to cause a machine to
allocate a memory space for firmware of an accelerator from a Kernel Data Protection (KDP)-protected region of a system memory, wherein the KDP-protected region is a specific area of the system memory that is protected by KDP; and
place the firmware of the accelerator in the KDP-protected region.

14. The machine-readable medium of claim 13, wherein the code is further to:
generate a device memory management unit (MMU) page table corresponding to the memory space allocation for the firmware of the accelerator; and
place the device MMU page table in the KDP-protected region.

15. The machine-readable medium of claim 14, wherein the code is further to set attributes of page table entries of the device MMU page table and accesses to the system memory is controlled based on the attributes of the page table entries of the device MMU page table.

16. The machine-readable medium of claim 15, wherein the code is further to set page table entries for accelerator firmware code and/or the device MMU page table read-only, execute-only, or read-write but no execute based on microcontroller capabilities in the device MMU page table attributes.

17. The machine-readable medium of claim 13, wherein the code is further to verify integrity of the firmware of the accelerator before placing the firmware in the KDP-protected region.

18. The machine-readable medium of claim 13, wherein the accelerator is one of a neural network accelerator, a digital signal processor, a graphics processing unit, an encryption processing unit, or a data compression processing unit.
